(19) United States
(12) Patent Application Publication
(10) Pub. No.: US 2024/0372078 A1
(43) Pub. Date: Nov. 7, 2024

(54) CATHODE FOR ALL-SOLID-STATE BATTERY AND A METHOD OF MANUFACTURING SAME

(71) Applicants: Hyundai Motor Company, Seoul (KR); Kia Corporation, Seoul (KR); Kyonggi University Industry & Academia Cooperation Foundation, Suwon (KR)

(72) Inventors: Jeong Hyun Seo, Dajeon (KR); Hong Seok Min, Yongin (KR); Sung Woo Noh, Seoul (KR); Je Sik Park, Seoul (KR); Im Sul Seo, Jincheon-Gun (KR); Ju Yeong Seong, Seongnam (KR); Chung Bum Lim, Suwon (KR); Yong Joon Park, Seoul (KR); Yong Jun Ji, Yongin (KR); Joo Young Lee, Pyeongtaek (KR); Myeong Jun Joo, Suwon (KR)

(21) Appl. No.: 18/242,947

(22) Filed: Sep. 6, 2023

(30) Foreign Application Priority Data
May 3, 2023 (KR) 10-2023-0057779

(51) Int. Cl. H01M 4/36; C01B 25/30; C01B 35/10; C01G 53/00; H01M 4/131; H01M 4/505; H01M 4/525

(52) U.S. Cl. CPC H01M 4/366; C01B 25/30; C01B 35/1027; C01G 53/50; H01M 4/131; H01M 4/505; H01M 4/525; C01P 2002/50; C01P 2004/03; C01P 2004/04; C01P 2006/40; H01M 2004/028

(57) ABSTRACT

Disclosed are a cathode for an all-solid-state battery including a composite-coated or double-coated cathode active material and a method of manufacturing the same.

### CROSS-REFERENCE TO RELATED APPLICATION

This application claims, under 35 U.S.C. § 119(a), the benefit of priority from Korean Patent Application No. 10-2023-0057779, filed on May 3, 2023, the entire contents of which are incorporated herein by reference.

### TECHNICAL FIELD

The present disclosure relates to a cathode for an all-solid-state battery including a composite-or double-coated cathode active material and a method of manufacturing the same.

### BACKGROUND

Sulfide-based solid electrolytes have recently been receiving attention as the most promising electrolytes for all-solid-state batteries because they have excellent lithium ion conductivity and form good interfaces with active materials even without heat treatment.

However, sulfide-based solid electrolytes are highly reactive and cause side reaction with a cathode active material, which is an oxide, thereby forming an unnecessary interfacial layer and deteriorating the electrochemical characteristics of the all-solid-state battery.

In the related art, a method of coating the surface of the cathode active material with a stable material has been reported. By coating the surface of the cathode active material to prevent direct contact of the cathode active material with the sulfide-based solid electrolyte, side reaction between the two components may be prevented from occurring.

The material coating the surface of the cathode active material for an all-solid-state battery has to possess lithium ion conductivity and low reactivity with the sulfide-based solid electrolyte. Moreover, electron conductivity of the material has to be as low as possible in order to prevent decomposition of the sulfide-based solid electrolyte by exchanging electrons with the cathode active material.

Currently, useful coating materials for cathode active materials for all-solid-state batteries include Li₂ZrO₃, LiNbO₃, LiTaO₃, and the like. In order to coat the cathode active material thinly and uniformly, an alkoxide-based precursor material having good wettability to the cathode active material has to be used. However, alkoxide-based precursor materials including elements such as zirconium, niobium, tantalum, etc. are very expensive and may not be suitable for mass production.

### SUMMARY

In preferred aspects, the present disclosure provide a cathode for an all-solid-state battery including a cathode active material including a thin and uniform coating layer and a method of coating a cathode active material using an inexpensive precursor material.

A term “all-solid-state battery” as used herein refers to a rechargeable secondary battery that includes an electrolyte in a solid state transferring ions between the electrodes of the battery.

In an aspect, provided is a cathode for an all-solid-state battery. The cathode includes a composite particle and a sulfide-based solid electrolyte. Particularly, the composite particle may include a core portion including a cathode active material and a shell portion coated onto the core portion, and the shell portion may include a first material represented by Chemical Formula 1 below and a second material represented by Chemical Formula 2 below:

$${Li}_{2 + x} {B}_{x} {O}_{3} \qquad [ Chemical Formula 1 ]$$

wherein x is 0<x≤1,

$${Li}_{2 + y} {P}_{y} {O}_{4} \qquad [ Chemical Formula 2 ]$$

wherein y is 0<y≤1.

In certain embodiments,

The cathode active material may include a compound represented by Chemical Formula 3 below.

### Chemical Formula 3

LiₓM1ₐM2_{b}M3_{c}O_{y}

In Chemical Formula 3, each of M1, M2, and M3 is independently selected from the group consisting of Ni, Co, Mn, Na, Mg, Ca, Ti, V, Cr, Cu, Zn, Ge, Sr, Ag, Ba, Zr, Nb, Mo, Al, Ga, and B, with 0<x≤1.1, 1.98≤y≤2.02, 0<a<1, 0<b<1, 0<c<1, and 0<a+b+c≤1.

The thickness of the shell portion may be about 0.5 nm to 50 nm.

The shell portion may include the first material and the second material in a mass ratio of about 1:0.25 to 1:4.

The composite particle may include an amount of about 97 wt % to 99.99 wt % of the core portion and an amount of about 0.01 wt % to 3 wt % of the shell portion, based on the total weight of the composite particle.

The shell portion may include a first shell disposed on the core portion and including the first material and a second shell disposed on the first shell and including the second material.

The shell portion may include the first shell and the second shell in a mass ratio of about 1:0.25 to 1:4.

In an aspect, provided is a method of manufacturing a cathode for an all-solid-state battery, including preparing a first solution including a lithium precursor, a boron precursor, and a phosphorus precursor, obtaining a second solution by adding a core portion including a cathode active material to the first solution, obtaining an intermediate in a powder form by drying the second solution, obtaining a composite particle by heat-treating the intermediate in an oxygen atmosphere, and manufacturing a cathode including the composite particles and a sulfide-based solid electrolyte.

The lithium precursor may suitably include lithium ethoxide.

The boron precursor may suitably include boric acid.

The phosphorus precursor may suitably include polyphosphoric acid.

In another aspect, provided is a method of manufacturing a cathode for an all-solid-state battery. The method includes steps of: preparing a first solution including a lithium precursor and a boron precursor, obtaining a second solution by adding a core portion including a cathode active material to the first solution, obtaining a first intermediate in a powder form by drying the second solution, obtaining a first composite particle including the core portion and a first shell disposed on the core portion and including a first material represented by Chemical Formula 1 by heat-treating the first intermediate in an oxygen atmosphere, preparing a third solution including a lithium precursor and a phosphorus precursor, obtaining a fourth solution by adding the first composite particle to the third solution, obtaining a second intermediate in a powder form by drying the fourth solution, obtaining a second composite particle including the first composite particle and a second shell disposed on the first shell and including a second material represented by Chemical Formula 2 by heat-treating the second intermediate in an oxygen atmosphere, and manufacturing a cathode including the second composite particle and a sulfide-based solid electrolyte.

Further provided is an all-solid-state battery including the cathode as described herein.

Also provided is a vehicle including the all-solid-state battery as described herein.

Other aspects of the invention are disclosed infra.

### BRIEF DESCRIPTION OF THE DRAWINGS

The above and other features of the present disclosure will now be described in detail with reference to certain exemplary embodiments thereof illustrated in the accompanying drawings, which are given hereinbelow by way of illustration only, and thus are not limitative of the present disclosure, and wherein:

FIG. 1 shows an exemplary all-solid-state battery according to an exemplary embodiment of the present disclosure;

FIG. 2 shows an exemplary composite particle according to an exemplary embodiment of the present disclosure;

FIG. 3 shows an exemplary composite particle according to an exemplary embodiment of the present disclosure;

FIG. 4 shows a scanning electron microscope image of the cathode active material used in Example 1;

FIG. 5 shows a scanning electron microscope image of the composite particle of Example 1;

FIG. 6 shows a scanning electron microscope image of the second composite particle of Example 2;

FIG. 7 shows a transmission electron microscope image of the cathode active material used in Example 1;

FIG. 8 shows a transmission electron microscope image of the composite particle of Example 1;

FIG. 9 shows a transmission electron microscope image of the second composite particle of Example 2;

FIG. 10 shows initial charge/discharge curves of all-solid-state batteries including cathodes including composite particles according to Examples 1 and 2 and Comparative Examples 1 to 3;

FIG. 11 shows results of measurement of changes in capacity during charging and discharging of the all-solid-state batteries including cathodes including composite particles according to Examples 1 and 2 and Comparative Examples 1 to 3;

FIG. 12 shows initial charge/discharge curves of all-solid-state batteries including cathodes including composite particles according to Examples 1 and 3 to 6 and Comparative Example 1;

FIG. 13 shows results of measurement of changes in capacity during charging and discharging of the all-solid-state batteries including cathodes including composite particles according to Examples 1 and 3 to 6 and Comparative Example 1;

FIG. 14 shows a Nyquist plot of the composite particles according to Comparative Example 1;

FIG. 15 shows a Nyquist plot of the composite particles according to Example 7; and

FIG. 16 shows a Nyquist plot of the composite particles according to Example 4.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

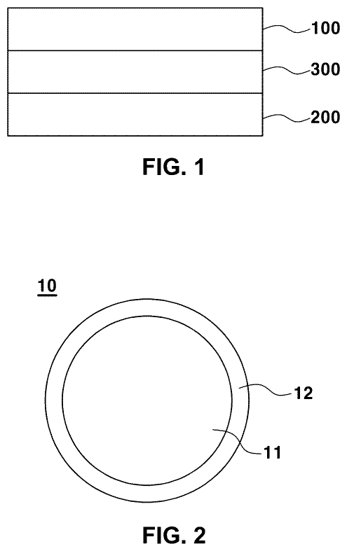

FIG. 1 shows an exemplary all-solid-state battery according to an exemplary embodiment of the present disclosure. The all-solid-state battery may include a cathode 100, an anode 200, and a solid electrolyte layer 300 interposed between the cathode 100 and the anode 200.

The cathode 100 may include a composite particle, a sulfide-based solid electrolyte, a conductive material, a binder, and the like.

FIG. 2 shows an exemplary composite particle 10 according to a first embodiment of the present disclosure. The composite particle 10 may include a core portion 11 including a cathode active material and a shell portion 12 applied or coated onto the core portion 11.

The core portion 11 may suitably include a cathode active material represented by LiₓM1ₐM2_{b},M3_{c}O_{y} (in which each of M1, M2, and M3 is independently selected from the group consisting of Ni, Co, Mn, Na, Mg, Ca, Ti, V, Cr, Cu, Zn, Ge, Sr, Ag, Ba, Zr, Nb, Mo, Al, Ga, and B, with 0<x≤1.1, 1.98≤y≤2.02, 0<a<1, 0<b<1, 0<c<1, and 0<a+b+c≤1).

The average particle diameter of the cathode active material is not particularly limited, and may be, for example, about 3 μm to 25 μm.

The shell portion 12 may include a first material represented by Chemical Formula 1 below and a second material represented by Chemical Formula 2 below:

$${Li}_{2 + x} {B}_{x} {O}_{3} , \qquad [ Chemical Formula 1 ]$$

wherein x may be 0<x≤1, and

$${Li}_{2 + y} {P}_{y} {O}_{4} \qquad [ Chemical Formula 2 ]$$

wherein y may be 0<y≤1.

The first material may suitably include Li₃BO₃. The second material may suitably include Li₃PO₄.

Since the first material has a strong B—O covalent bond, reactivity thereof to a sulfide-based solid electrolyte is low.

The second material is also chemically stable because it has a strong P—O covalent bond. Also, since the second material includes O²⁻, which is an anion that is also present in the cathode active material, and P⁵⁺, which is a cation that is also present in the sulfide-based solid electrolyte, interdiffusion of sulfur(S) ions and phosphorus (P) ions of the sulfide-based solid electrolyte and transition metal ions and oxygen (O) ions of the cathode active material may be prevented. Interdiffusion between the cathode active material and the sulfide-based solid electrolyte is caused by binding of oxygen (O) in the cathode active material and phosphorus (P) in the sulfide-based solid electrolyte. The second material already has a PO⁴⁻bond, and thus the second material is capable of preventing side reaction between the cathode active material and the sulfide-based solid electrolyte.

The thickness of the shell portion 12 may be about 0.5 nm to 50 nm. When the thickness of the shell portion 12 is greater than about 50 nm, internal resistance of the cathode 100 may increase and battery performance may deteriorate.

The shell portion 12 may include the first material and the second material in a mass ratio of about 1:0.25 to 1:4. When the mass ratio of the first material to the second material falls within the above numerical range, side reaction between the cathode active material and the sulfide-based solid electrolyte may be suppressed, thus improving battery performance.

The composite particle 10 may include an amount of about 97 wt % to 99.99 wt % of the core portion 11 and an amount of about 0.01 wt % to 3 wt % of the shell portion 12, whereas wt % is based on the total weight of the composite particle. When the amount of the shell portion 12 is greater than about 3 wt %, internal resistance of the cathode 100 may increase and battery performance may deteriorate.

A method of manufacturing a cathode including the composite particle 10 of the first embodiment may include preparing a first solution including a lithium precursor, a boron precursor, and a phosphorus precursor, obtaining a second solution by adding a core portion including a cathode active material to the first solution, obtaining an intermediate in a powder form by drying the second solution, obtaining the composite particle by heat-treating the intermediate in an oxygen atmosphere, and manufacturing a cathode including the composite particle and a sulfide-based solid electrolyte.

The lithium precursor may suitably include lithium ethoxide. The boron precursor may suitably include boric acid. The phosphorus precursor may suitably include polyphosphoric acid. The boric acid is a precursor of the first material, and the polyphosphoric acid is a precursor of the second material. Since both boric acid and polyphosphoric acid are inexpensive, a thin and uniform shell portion may be manufactured with inexpensive materials according to the present disclosure.

The amounts of the lithium precursor, the boron precursor, and the phosphorus precursor in the first solution are not particularly limited, and respective precursors may be appropriately weighed and prepared depending on the desired composition of the first material and the second material.

The first solution may be prepared by dissolving the lithium precursor, the boron precursor, and the phosphorus precursor in a solvent. Any solvent may be used, so long as it is able to dissolve the lithium precursor, the boron precursor, and the phosphorus precursor, and an example thereof may include an alcohol-based solvent.

The second solution may be obtained by adding the core portion including a cathode active material to the first solution, and the intermediate in a powder form may be obtained by drying the second solution to remove the solvent.

The drying may be performed using any device or method, so long as the solvent may be completely removed. For example, the second solution may be dried with stirring at about 40° C. to 100° C. for about 1 hour to 10 hours. Also, vacuum drying the intermediate at about 70° C. to 150° C. for about 1 hour to 6 hours may be further performed in order to completely remove the remaining solvent.

The composite particle 10 may be manufactured by heat-treating the intermediate at about 200° C. to 500° C. for about 1 hour to 5 hours in an oxygen atmosphere to induce reaction between the lithium precursor, the boron precursor, and the phosphorus precursor.

The method of manufacturing the cathode is not particularly limited, and may be performed in a dry or wet manner. For example, a cathode may be manufactured by coating a substrate with a slurry including the composite particle 10, a sulfide-based solid electrolyte, a conductive material, and a binder and then performing drying.

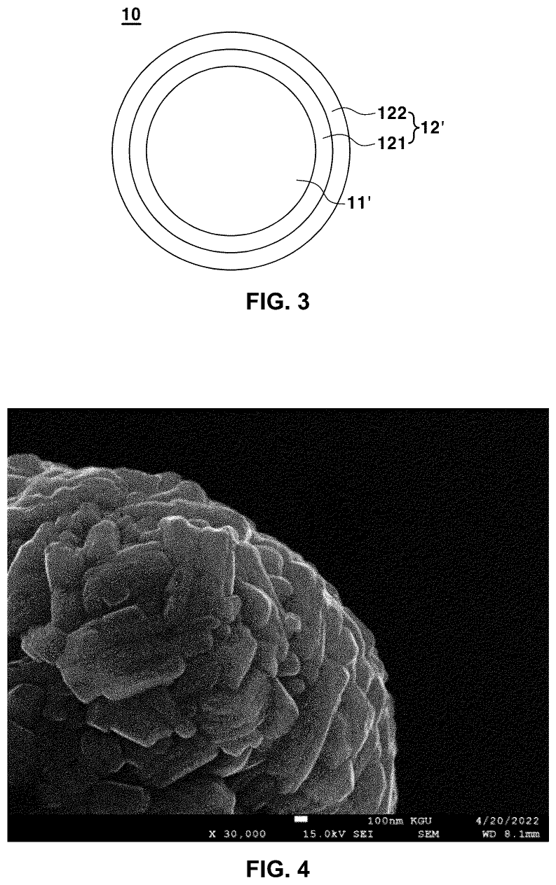

FIG. 3 shows an exemplary composite particle 10′ according to a second embodiment of the present disclosure. The composite particle 10′ may include a core portion 11′ including a cathode active material and a shell portion 12′ applied or coated onto the core portion 11′. The shell portion 12′ may include a first shell 121 located on the core portion 11′ and including a first material represented by Chemical Formula 1 below and a second shell 122 located on the first shell 121 and including a second material represented by Chemical Formula 2 below:

$${Li}_{2 + x} {B}_{x} {O}_{3} \qquad [ Chemical Formula 1 ]$$

wherein x may be 0<x≤1, and

$${Li}_{2 + y} {P}_{y} {O}_{4} \qquad [ Chemical Formula 2 ]$$

wherein y may be 0<y≤1.

The first material may suitably include Li₃BO₃. The second material may suitably include Li₃PO₄.

The shell portion 12′ may include the first shell 121 and the second shell 122 in a mass ratio of about 1:0.25 to 1:4.

Further provided is a method of manufacturing a cathode including the composite particle 10′ of the second embodiment. The method may include preparing a first solution including a lithium precursor and a boron precursor, obtaining a second solution by adding a core portion including a cathode active material to the first solution, obtaining a first intermediate in a powder form by drying the second solution, obtaining a first composite particle including the core portion and a first shell located on the core portion by heat-treating the first intermediate in an oxygen atmosphere, preparing a third solution including a lithium precursor and a phosphorus precursor, obtaining a fourth solution by adding the first composite particle to the third solution, obtaining a second intermediate in a powder form by drying the fourth solution, obtaining a second composite particle each including the first composite particle and a second shell located on the first shell by heat-treating the second intermediate in an oxygen atmosphere, and manufacturing a cathode including the second composite particle and a sulfide-based solid electrolyte.

The lithium precursor may include suitably lithium ethoxide. The boron precursor may include suitably boric acid.

The amounts of the lithium precursor and the boron precursor in the first solution are not particularly limited, and respective precursors may be appropriately weighed and prepared depending on the desired composition of the first material.

The first solution may be prepared by dissolving the lithium precursor and the boron precursor in a solvent. Here, any solvent may be used, so long as it is able to dissolve the lithium precursor and the boron precursor, and an example thereof may include an alcohol-based solvent.

The second solution may be obtained by adding the core portion including a cathode active material to the first solution, and the first intermediate in a powder form may be obtained by drying the second solution to remove the solvent.

The drying may be performed using any device or method so long as the solvent may be completely removed. For example, the second solution may be dried with stirring at about 40° C. to 100° C. for about 1 hour to 10 hours. Also, vacuum drying the first intermediate at about 70° C. to 150° C. for about 1 hour to 6 hours may be further performed in order to completely remove the remaining solvent.

The first intermediate thus obtained may be heat-treated at about 200° C. to 500° C. for about 1 hour to 5 hours in an oxygen atmosphere to induce reaction between the lithium precursor and the boron precursor, thereby manufacturing the first composite particle including a core portion and a first shell.

The phosphorus precursor may suitably include polyphosphoric acid.

The amounts of the lithium precursor and the phosphorus precursor in the third solution are not particularly limited, and respective precursors may be appropriately weighed and prepared depending on the desired composition of the second material.

The third solution may be prepared by dissolving the lithium precursor and the phosphorus precursor in a solvent. Any solvent may be used so long as it is able to dissolve the lithium precursor and the phosphorus precursor, and an example thereof may include an alcohol-based solvent. This solvent may be the same as or different from the solvent included in the first solution.

The fourth solution may be obtained by adding the first composite particle to the third solution, and the second intermediate in a powder form may be obtained by drying the fourth solution to remove the solvent.

The drying may be performed using any device or method so long as the solvent may be completely removed. For example, the fourth solution may be dried with stirring at about 40° C. to 100° C. for about 1 hour to 10 hours. Also, vacuum drying the second intermediate at about 70° C. to 150° C. for about 1 hour to 6 hours may be further performed in order to completely remove the remaining solvent.

The second intermediate thus obtained may be heat-treated in an oxygen atmosphere at about 200° C. to 500° C. for about 1 hour to 5 hours to induce reaction between the lithium precursor and the phosphorus precursor, thereby manufacturing the second composite particle each configured such that the second shell is formed on the first shell.

The method of manufacturing the cathode is not particularly limited, and may be performed in a dry or wet manner. For example, a cathode may be manufactured by coating a substrate with a slurry including the second composite particle, a sulfide-based solid electrolyte, a conductive material, and a binder and performing drying.

Examples of the sulfide-based solid electrolyte may include Li₂S-P₂S₅, Li₂S-P₂S₅-LiI, Li₂S-P₂S₅-LiCl, Li₂S-P₂S₅-LiBr, Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂-P₂S₅-LiI, Li₂S-B₂S₃, Li₂S-P₂S₅-ZₘSₙ (in which m and n are positive numbers and Z is any one selected from among Ge, Zn, and Ga), Li₂S-GeS₂, Li₂S-SiS₂-Li₃PO₄, Li₂S-SiS₂-LiₓMO_{y} (in which x and y are positive numbers and M is any one selected from among P, Si, Ge, B, Al, Ga, and In), Li₁₀GeP₂S₁₂, and the like.

Examples of the conductive material may suitably include carbon black, conductive graphite, ethylene black, graphene, and the like.

Examples of the binder may suitably include butadiene rubber, nitrile butadiene rubber, hydrogenated nitrile butadiene rubber, polyvinylidene fluoride, polytetrafluoroethylene, and the like.

### EXAMPLE

A better understanding of the present disclosure may be obtained through the following examples. These examples are merely set forth to illustrate the present disclosure, and are not to be construed as limiting the scope of the present disclosure.

### Example 1

A composite particle including about 99.8 wt % of a core portion and about 0.2 wt % of a shell portion, based on the total weight of the composite particle, was manufactured as follows. The amounts of precursors were adjusted so that the shell portion included about 0.05 wt % of a first material and about 0.15 wt % of a second material based on the total weight of the composite particle.

A first solution was prepared by dissolving lithium ethoxide, boric acid, and polyphosphoric acid in an alcohol-based solvent. A second solution was obtained by adding about 5 g of the core portion including LiNi_{0.8}Co_{0.1}Mn_{0.1}O₂ as a cathode active material to about 30 ml of the first solution.

The second solution was dried with stirring at about 70° C. for about 4 hours until the solvent was completely evaporated to obtain an intermediate. The intermediate was vacuum-dried at about 90° C. for about 2 hours, thus completely removing the remaining solvent.

The intermediate was heat-treated at about 400° C. for about 1 hour in an oxygen atmosphere, thereby obtaining the composite particle including the core portion and the shell portion.

### Example 2

A composite particle including about 99.8 wt % of a core portion and about 0.2 wt % of a shell portion, based on the total weight of the composite particle, was manufactured as follows. The shell portion was composed of a first shell including a first material and a second shell including a second material, and the amounts of precursors were adjusted so that the amount of the first shell was about 0.05 wt % and the amount of the second shell was about 0.15 wt %, based on the total weight of the composite particle.

A first solution was prepared by dissolving lithium ethoxide and boric acid in a solvent. A second solution was obtained by adding about 5 g of the core portion including LiNi_{0.8}Co_{0.1}Mn_{0.1}O₂ as a cathode active material to about 30 ml of the first solution.

The second solution was dried with stirring at about 70° C. for about 4 hours until the solvent was completely evaporated to obtain a first intermediate. The first intermediate was vacuum-dried at about 90° C. for about 2 hours, thus completely removing the remaining solvent.

The first intermediate was heat-treated at about 400° C. for about 1 hour in an oxygen atmosphere, thereby obtaining the first composite particle including the core portion and the first shell.

A third solution was prepared by dissolving lithium ethoxide and polyphosphoric acid in a solvent. A fourth solution was obtained by adding about 5 g of the first composite particles to about 30 ml of the third solution.

The fourth solution was dried with stirring at about 70° C. for about 4 hours until the solvent was completely evaporated to obtain a second intermediate. The second intermediate was vacuum-dried at about 90° C. for about 2 hours, thus completely removing the remaining solvent.

The second intermediate was heat-treated at about 400° C. for about 1 hour in an oxygen atmosphere, thereby obtaining the second composite particle each including the core portion, the first shell, and the second shell.

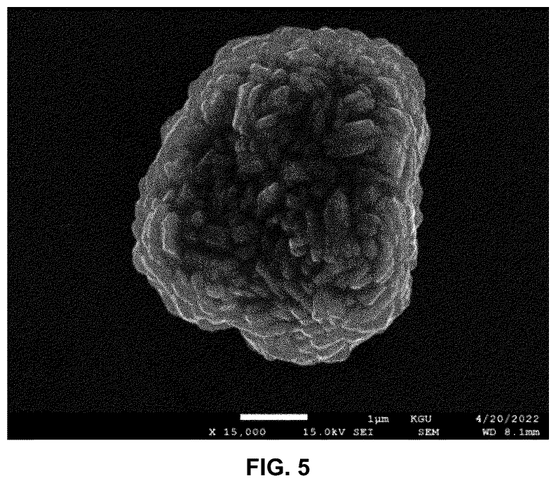

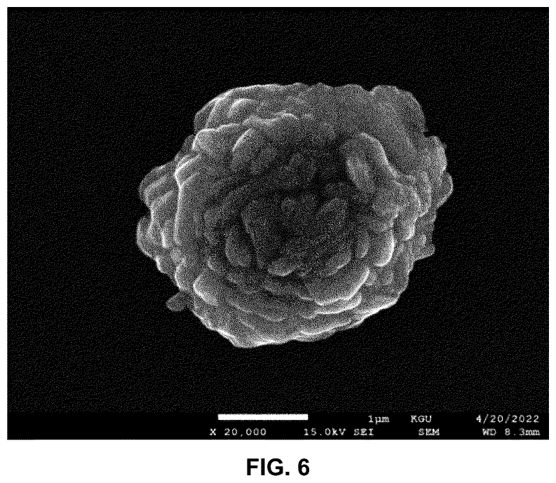

FIG. 4 shows a scanning electron microscope image of the cathode active material used in Example 1. FIG. 5 shows a scanning electron microscope image of the composite particle of Example 1. FIG. 6 shows a scanning electron microscope image of the second composite particle of Example 2. As shown in FIGS. 5 and 6, no foreign matter was found on the surface of each particle and also that the shell portion was formed thinly and uniformly.

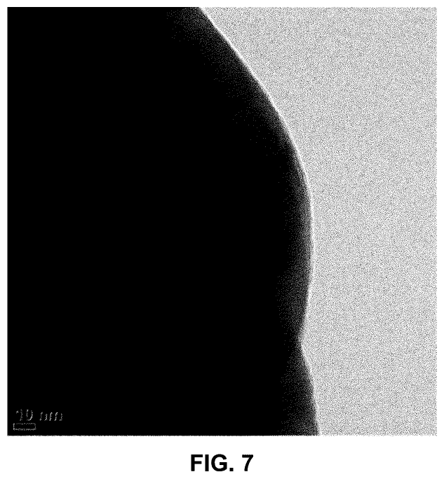

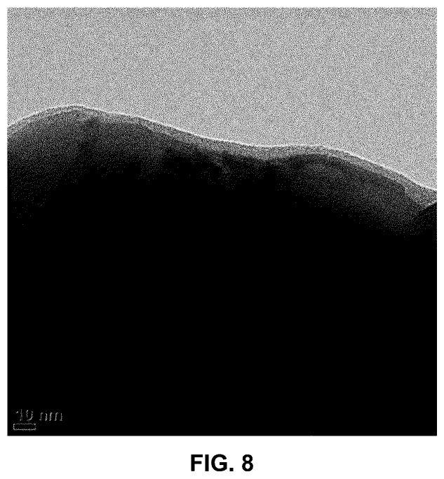

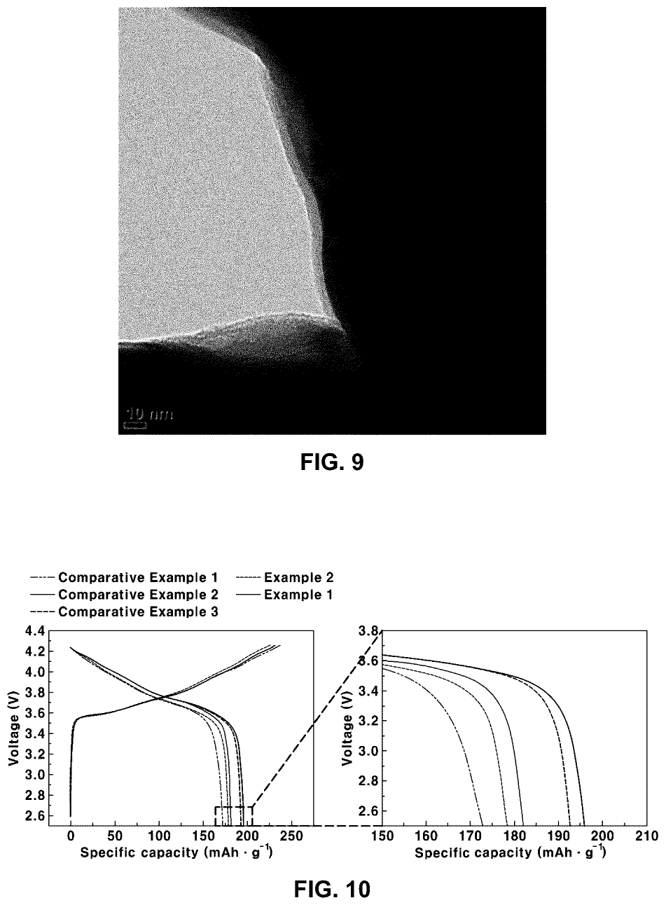

FIG. 7 shows a transmission electron microscope image of the cathode active material used in Example 1. FIG. 8 shows a transmission electron microscope image of the composite particle of Example 1. FIG. 9 shows a transmission electron microscope image of the second composite particle of Example 2. In order to eliminate the influence of lithium residue present in each sample, each sample was washed with distilled water and then observed using a transmission electron microscope. When comparing FIGS. 8 and 9 with FIG. 7, a very thin and uniform shell portion was formed on the surface of the cathode active material.

### Comparative Example 1

A cathode active material without a shell portion was set as Comparative Example 1. The same cathode active material as in Example 1 was used.

### Comparative Example 2

A composite particle was manufactured in the same manner as in Example 2, with the exception that only the first shell was formed and the second shell was not formed.

### Comparative Example 3

A composite particle was manufactured in the same manner as in Example 2, with the exception that the first shell was not formed and the second shell was formed on the surface of the cathode active material.

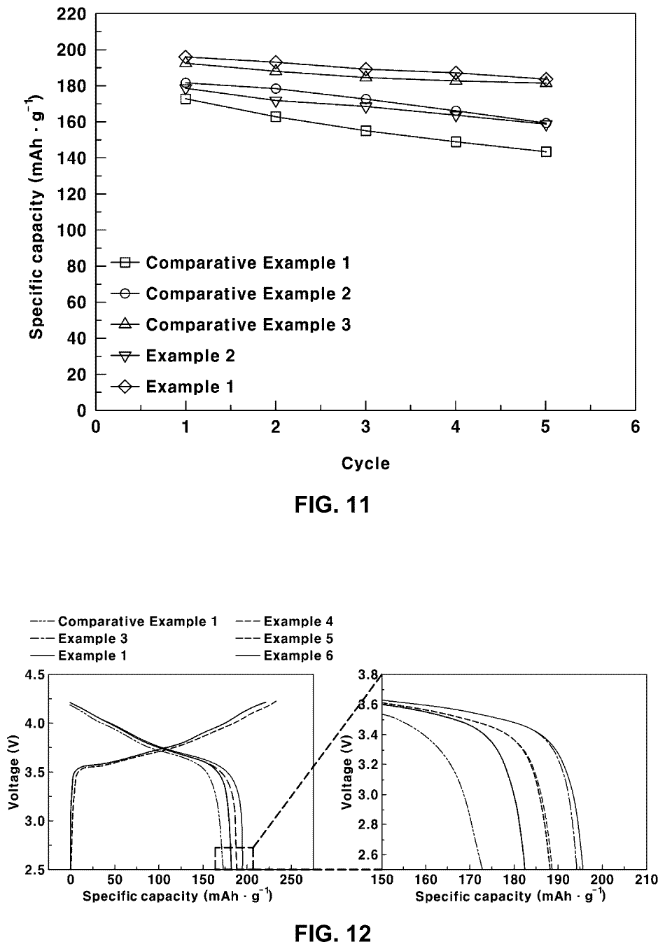

FIG. 10 shows initial charge/discharge curves of all-solid-state batteries including cathodes including the composite particles of Examples 1 and 2 and Comparative Examples 1 to 3. FIG. 11 shows results of measurement of changes in capacity during charging and discharging of the all-solid-state batteries including cathodes including the composite particles of Examples 1 and 2 and Comparative Examples 1 to 3. Both Example 1 and Example 2 exhibited superior discharge capacity compared to Comparative Example 1 in which the shell portion was not formed.

### Example 3

A composite particle was manufactured in the same manner as in Example 1, with the exception that the amounts of the precursors were adjusted so that the shell portion included about 0.05 wt % of the first material and about 0.1 wt % of the second material based on the total weight of the composite particle.

### Example 4

A composite particle was manufactured in the same manner as in Example 1, with the exception that the amounts of the precursors were adjusted so that the shell portion included about 0.1 wt % of the first material and about 0.1 wt % of the second material, based on the total weight of the composite particle.

### Example 5

A composite particle was manufactured in the same manner as in Example 1, with the exception that the amounts of the precursors were adjusted so that the shell portion included about 0.1 wt % of the first material and about 0.15 wt % of the second material, based on the total weight of the composite particle.

### Example 6

A composite particle was manufactured in the same manner as in Example 1, with the exception that the amounts of the precursors were adjusted so that the shell portion included about 0.15 wt % of the first material and about 0.1 wt % of the second material, based on the total weight of the composite particle.

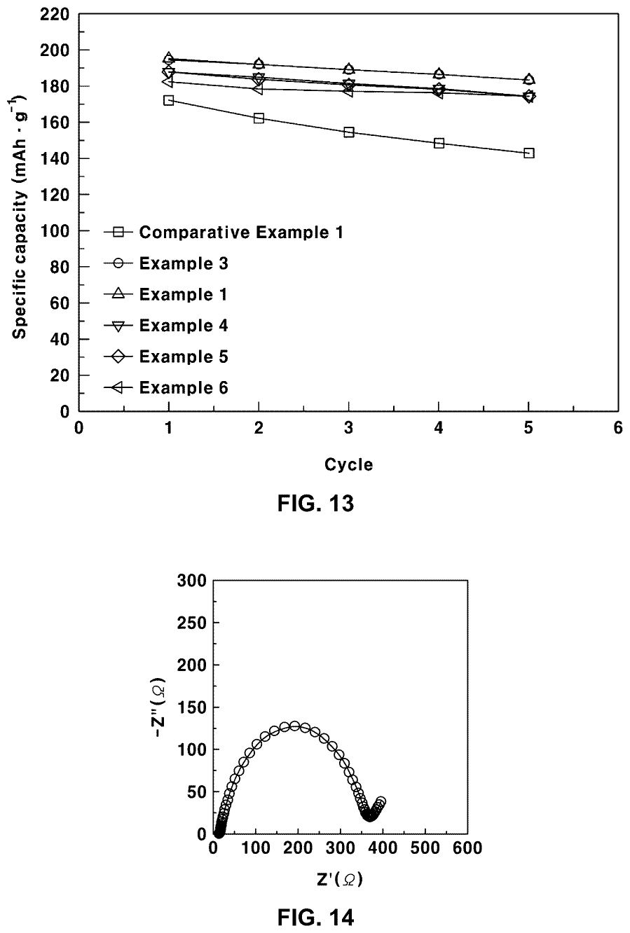

FIG. 12 shows initial charge/discharge curves of all-solid-state batteries including cathodes including the composite particles of Examples 1 and 3 to 6 and Comparative Example 1. FIG. 13 shows results of measurement of changes in capacity during charging and discharging of the all-solid-state batteries including cathodes including the composite particles of Examples 1 and 3 to 6 and Comparative Example 1. Examples 1 and 3 to 6 all exhibited superior discharge capacity compared to Comparative Example 1 in which the shell portion was not formed.

The charge/discharge capacities and initial efficiencies of the all-solid-state batteries including the cathodes including the composite particles according to Examples 1 and 3 to 6 and Comparative Examples 1 to 3 are shown in Table 1 below. These results were measured at a discharge voltage of 4.25-2.5 vs Li+/Li and a temperature of 30±2° C.

TABLE 1

| | | Charge | Discharge | |
|---|---|---|---|---|
| | | capacity | capacity | Initial |
| Classification | Shell portion¹⁾ | [mAh/g] | [mAh/g] | efficiency |
| Comparative | — | 236.2 | 172.9 | 73.2 |
| Example 1 | | | | |
| Comparative | 0.05 wt % of LBO | 226.6 | 182.1 | 80.36 |
| Example 2 | | | | |
| Comparative | 0.15 wt % of LPO | 228.5 | 192.7 | 84.33 |
| Example 3 | | | | |
| Example 1 | 0.05 wt % of LBO + | 230.5 | 195.9 | 84.99 |
| | 0.15 wt % of LPO | | | |
| Example 3 | 0.05 wt % of LBO + | 232.3 | 194.5 | 83.73 |
| | 0.1 wt % of LPO | | | |
| Example 4 | 0.1 wt % of LBO + | 230.1 | 188.7 | 82.01 |
| | 0.1 wt % of LPO | | | |
| Example 5 | 0.1 wt % of LBO + | 233.4 | 188.3 | 80.68 |
| | 0.15 wt % of LPO | | | |
| Example 6 | 0.15 wt % of LBO + | 219.6 | 182.8 | 83.24 |
| | 0.1 wt % of LPO | | | |

¹⁾LBO indicates Li₃BO₃ and LPO indicates Li₃PO₄

As shown in Table 1, Examples 1 and 3 to 6 exhibited high charge/discharge capacity and initial efficiency compared to Comparative Example 1.

### Example 7

A composite particle was manufactured in the same manner as in Example 2, with the exception that the amounts of the precursors were adjusted so that the amount of the first shell was about 0.1 wt % and the amount of the second shell was about 0.1 wt %, based on the total weight of the composite particle.

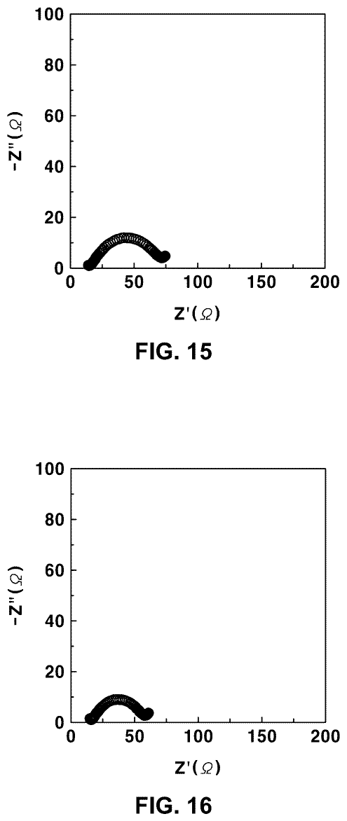

FIG. 14 shows a Nyquist plot of the composite particle according to Comparative Example 1. FIG. 15 shows a Nyquist plot of the composite particle according to Example 7. FIG. 16 shows a Nyquist plot of the composite particle according to Example 4. The composite particles according to Examples 4 and 7 exhibited a small semicircle size compared to Comparative Example 1, indicating that the impedance value of the cell was reduced. Therefore, according to the present disclosure, resistance of the cathode can be effectively lowered.

As is apparent from the above description, according to various exemplary embodiments of the present disclosure, a cathode for an all-solid-state battery containing a cathode active material including a thin and uniform coating layer can be obtained.

According to various exemplary embodiments of the present disclosure, the cathode active material can be coated thinly and uniformly with inexpensive precursor materials.

The effects of the present disclosure are not limited to the above-mentioned effects. It should be understood that the effects of the present disclosure include all effects that can be inferred from the description of the present disclosure.

As the exemplary embodiments of the present disclosure have been described in detail above, the scope of the present disclosure is not limited to the above-described embodiments, and various modifications and improvements made by those skilled in the art using the basic concept of the present disclosure defined in the following claims are also within the scope of the present disclosure.

What is claimed is:

1. A cathode for an all-solid-state battery, comprising:
a composite particle; and
a sulfide-based solid electrolyte,
wherein the composite particle comprises a core portion comprising a cathode active material and a shell portion coated onto the core portion, and
the shell portion comprises a first material represented by Chemical Formula 1 and a second material represented by Chemical Formula 2:
$${Li}_{2 + x} {B}_{x} {O}_{3} \qquad [ Chemical Formula 1 ]$$
wherein x is 0<x≤1; and
$${Li}_{2 + y} {P}_{y} {O}_{4} \qquad [ Chemical Formula 2 ]$$
wherein y is 0<y≤1.

2. The cathode of claim 1, wherein the cathode active material comprises a compound represented by Chemical Formula 3:
[Chemical Formula 3]
LiₓM1ₐM2_{b}M3_{c}O_{y}
wherein each of M1, M2, and M3 is independently selected from the group consisting of Ni, Co, Mn, Na, Mg, Ca, Ti, V, Cr, Cu, Zn, Ge, Sr, Ag, Ba, Zr, Nb, Mo, Al, Ga, and B, and
0<x≤1.1, 1.98≤y≤2.02, 0<a<1, 0<b<1, 0<c<1, and 0<a+b+c≤1.

3. The cathode of claim 1, wherein a thickness of the shell portion is about 0.5 nm to 50 nm.

4. The cathode of claim 1, wherein the shell portion comprises the first material and the second material in a mass ratio of about 1:0.25 to 1:4.

5. The cathode of claim 1, wherein the composite particle comprises an amount of about 97 wt % to 99.99 wt % of the core portion and an amount of about 0.01 wt % to 3 wt % of the shell portion, based on the total weight of the composite particle.

6. The cathode of claim 1, wherein the shell portion comprises a first shell disposed on the core portion and comprising the first material and a second shell disposed on the first shell and comprising the second material.

7. The cathode of claim 6, wherein the shell portion comprises the first shell and the second shell in a mass ratio of about 1:0.25 to 1:4.

8. A method of manufacturing a cathode for an all-solid-state battery, comprising:
preparing a first solution comprising a lithium precursor, a boron precursor, and a phosphorus precursor;
obtaining a second solution by adding a core portion comprising a cathode active material to the first solution;
obtaining an intermediate in a powder form by drying the second solution;
obtaining a composite particle by heat-treating the intermediate in an oxygen atmosphere; and
manufacturing a cathode comprising the composite particle and a sulfide-based solid electrolyte,
wherein the composite particle comprises the core portion and a shell portion coated onto the core portion, and
the shell portion comprises a first material represented by Chemical Formula 1 and a second material represented by Chemical Formula 2:
$${Li}_{2 + x} {B}_{x} {O}_{3} \qquad [ Chemical Formula 1 ]$$
wherein x is 0<x≤1; and
$${Li}_{2 + y} {P}_{y} {O}_{4} \qquad [ Chemical Formula 2 ]$$
wherein y is O<y≤1.

9. The method of claim 8, wherein the lithium precursor comprises lithium ethoxide.

10. The method of claim 8, wherein the boron precursor comprises boric acid.

11. The method of claim 8, wherein the phosphorus precursor comprises polyphosphoric acid.

12. The method of claim 8, wherein the cathode active material comprises a compound represented by Chemical Formula 3:
[Chemical Formula 3]
LiₓM1ₐM2_{b},M3_{c}O_{y}
wherein each of M1, M2, and M3 is independently selected from the group consisting of Ni, Co, Mn, Na, Mg, Ca, Ti, V, Cr, Cu, Zn, Ge, Sr, Ag, Ba, Zr, Nb, Mo, Al, Ga, and B; and
0<x≤1.1, 1.98≤y≤2.02, 0<a<1, 0<b<1, 0<c<1, and 0<a+b+c≤1.

13. The method of claim 8, wherein the shell portion comprises the first material and the second material in a mass ratio of about 1:0.25 to 1:4.

14. The method of claim 8, wherein the composite particle comprises an amount of about 97 wt % to 99.99 wt % of the core portion and an amount of about 0.01 wt % to 3 wt % of the shell portion, based on the total weight of the composite particle.

15. A method of manufacturing a cathode for an all-solid-state battery, comprising:
preparing a first solution comprising a lithium precursor and a boron precursor;
obtaining a second solution by adding a core portion comprising a cathode active material to the first solution;
obtaining a first intermediate in a powder form by drying the second solution;
obtaining a first composite particle comprising the core portion and a first shell disposed on the core portion and comprising a first material represented by Chemical Formula 1 by heat-treating the first intermediate in an oxygen atmosphere:
$${Li}_{2 + x} {B}_{x} {O}_{3} \qquad [ Chemical Formula 1 ]$$
wherein x is 0<x≤1;
preparing a third solution comprising a lithium precursor and a phosphorus precursor;
obtaining a fourth solution by adding the first composite particle to the third solution;
obtaining a second intermediate in a powder form by drying the fourth solution;
obtaining a second composite particle comprising the first composite particle and a second shell disposed on the first shell and comprising a second material represented by Chemical Formula 2 by heat-treating the second intermediate in an oxygen atmosphere:
$${Li}_{2 + y} {P}_{y} {O}_{4} \qquad [ Chemical Formula 2 ]$$
wherein y is 0<y≤1; and
manufacturing a cathode comprising the second composite particle and a sulfide-based solid electrolyte.

16. The method of claim 15, wherein the lithium precursor comprises lithium ethoxide.

17. The method of claim 15, wherein the boron precursor comprises boric acid.

18. The method of claim 15, wherein the phosphorus precursor comprises polyphosphoric acid.

19. The method of claim 15, wherein a mass ratio of the first shell to the second shell is about 1:0.25 to 1:4.

20. The method of claim 15, wherein the second composite particle comprises an amount of about 97 wt % to 99.99 wt % of the core portion and an amount of about 0.01 wt % to 3 wt % of the first shell and the second shell, based on the total weight of the composite particle.
